(19) United States
(12) Patent Application Publication
(10) Pub. No.: US 2005/0066240 A1
(43) Pub. Date: Mar. 24, 2005

(54) Data quality & integrity engine

(75) Inventors: Michael John Sykes, Aldgate (AU); Daniel Seth Weinstein, Flemington (AU); Jason Scott Beer, Hawthorne East (AU)

Correspondence Address: BURNS DOANE SWECKER & MATHIS L L P, POST OFFICE BOX 1404, ALEXANDRIA, VA, 22313-1404, US

(73) Assignee: Tenix Investments Pty Ltd, New South Wales (AU)

(21) Appl. No.: 10/677,298

(22) Filed: Oct. 3, 2003

(30) Foreign Application Priority Data
Oct. 4, 2002 (AU) 2002951910

(51) Int. Cl. G06F 11/00

(52) U.S. Cl. 714/48

(57) ABSTRACT

Methods, systems, and computer program products for ensuring data quality and integrity of a data set derived from a data source are described. The data source may be one or more data repositories or data warehouses, or one or more transaction systems. Data from the data source may be stored in a staging area. A data repository is built using the data. The data repository comprises a data structure that forms a model of the data from the data source. The building step involves applying business rules from a rules database to the data. The business rules are dependent upon meta data. The building step further involves detecting any errors in the data and storing data satisfying the business rules in the data repository. A log of any detected errors may be maintained in the data repository.

### FIELD OF THE INVENTION

The present invention relates generally to database systems, and in particular to data warehousing techniques.

### BACKGROUND

All types of organisations, business entities, and persons may own legacy database systems that have been acquired at different times. A business may rely upon a particular database or transaction system to handle data aggregation and processing functions for a part of a business. Because of investment, knowledge, and experience with that system, an organisation or entity may choose not to replace such a system, for example simply to avail itself of the stability of the system. Later, another database or transaction system may be acquired and used to handle a different aspect of the business. In this manner, an entity may ultimately operate a number of database systems that do not interact well or at all with one another. In a similar manner, an entity may have its own database or transaction system(s) and need to interact with a number of different databases or transaction systems of other entities. For example, a number of entities may be working collaboratively on a project, but each have their own database or transaction systems.

One approach to resolving this problem is to mandate the use of a standard database system throughout the entity or entities. However, this may not be possible or desirable for a number of reasons. For example, an entity working collaboratively with others for a short-term project may consider this to be too onerous of a requirement and therefore unjustifiable.

Data warehouses have attempted to address this problem to collect data from various sources, but suffer from a number of disadvantages. FIG. 1 illustrates a system 100 in which a data warehouse 102 receives data from a number of databases 110-122, which is used to produce deliverable data 130. However, such a data warehouse 102 produces mismatches in the data 130. This results from errors in the data itself (e.g. due to data entry problems), synchronization problems (e.g., a database may not yet have been amended), and conceptual differences. Relevant conceptual differences comprise like fields not having the same name, unlike fields having the same name, like fields having different definitions and/or formats, and like entities having different attributes, to name a few.

There has been little synergy between various databases in such circumstances, and users may need to learn a number of different application to find information the users need from such disparate databases.

Thus a need clearly exists for an improved method of ensuring quality and integrity of data from a data source.

### SUMMARY

In accordance with a first aspect of the invention, a method of ensuring data quality and integrity of a data set derived from a data source is provided. The method comprises the steps of: obtaining data from the data source; and building a data repository using the data from the data source. The data repository comprises a data structure that forms a model of the data from the data source. The building step comprises the steps of: applying business rules from a rules database to the data from the data source, where the business rules are dependent upon meta data; and detecting any errors in the data and storing data satisfying the business rules in the data repository.

A log of any detected errors may be maintained in the data repository. Preferably, the detected errors are reported for correction of the errors in the data source. Optionally, an integrated data set can be provided for export from the data repository.

Optionally, the data source comprises a plurality of database systems and/or transaction systems. The method may comprise the step of storing the data from the plurality of systems in a staging area. More preferably, the model is an enterprise-level model and the business rules are enterprise level business rules.

The method may comprise the step of feeding back the errors to the data source for correction. Further, at least a portion of data of the data source is corrected dependent upon an error fed back to the data source.

Preferably, the applying step comprises the step of invoking procedures stored in the data repository. The meta data may be stored in the data repository. Optionally, the data from the data source is loaded into a staging area. Further, the method comprises the step of triggering the building step. The rules database comprises one or more attributes for each rule selected from the group consisting of: rule type, rule name, a text description of the rule, rule syntax, invocation of the rule, reporting of erroneous data to the enterprise-level model, name of a stored procedure for checking the rule, rule precedence, a target table identifier, a target column name, activation status of the rule, status information of whether or not the rule is required for complete data quality and integrity, an error identifier, status information of whether or not the rule is traceable back to the data from the transaction systems, and a parameter list, if required by the stored procedure.

Preferably, each rule of the rules database comprises a SQL statement.

In accordance with further aspects of the invention, systems and a computer program products for ensuring data quality and integrity of a data set derived from a data source are provided that implement the method of the foregoing aspect.

### BRIEF DESCRIPTION OF THE DRAWINGS

A small number of embodiments of the invention are described hereinafter with reference to the drawings, in which:

FIG. 1 is a block diagram of a system using a data warehouse to provide deliverable data;

FIG. 2 is a block diagram of a data quality and integrity engine for data from a plurality of different database or transaction systems;

FIGS. 3A, 3B and 3C are a flow diagram of a representative process for loading data into a data repository that can be used in the system of FIG. 2;

FIG. 4 is a flow diagram illustrating the process of the data quality and integrity engine of FIG. 2;

FIG. 5 is a flow diagram illustrating a process of ensuring data quality and integrity of a data set derived from a data source;

FIG. 6 is a detailed flowing diagram of a step of building a data repository in FIG. 5; and

FIG. 7 is a high-level block diagram of a general-purpose computer system with which embodiments of the invention may be practiced.

### DETAILED DESCRIPTION

Methods, systems, and computer program products for ensuring data quality and integrity of a data set derived from a data source are described. Numerous specific details are set forth in the following description including particular data interchange formats, database systems, and the like. However, it will be apparent to those skilled in the art in the light of this disclosure that modifications and/or substitutions may be made without departing from the scope and spirit of the invention. In other instances, well-known details may be omitted so as not to obscure the embodiments of the invention.

The methods for ensuring data quality and integrity of a data set derived from a data source may be implemented in modules. A module, and in particular its functionality, can be implemented in either hardware or software. In the software sense, a module is a process, program, or portion thereof, that usually performs a particular function or related functions. Such software may be implemented in C, C++, ADA, Fortran, for example, but may be implemented in any of a number of other programming languages/systems, or combinations thereof. In the hardware sense, a module is a functional hardware unit designed for use with other components or modules. For example, a module may be implemented using discrete electronic components, or it can form a portion of an entire electronic circuit such as an Field Programmable Gate Arrays (FPGA), Application Specific Integrated Circuit (ASIC), and the like. A physical implementation may also comprise configuration data for a FPGA, or a layout for an ASIC, for example. Still further, the description of a physical implementation may be in EDIF netlisting language, structural VHDL, structural Verilog or the like. Numerous other possibilities exist. Those skilled in the art will appreciate that the system can also be implemented as a combination of hardware and software modules.

Some portions of the description are explicitly or implicitly presented in terms of algorithms and representations of operations on data within a computer system or other device capable of performing computations, e.g. a personal digital assistant (PDA), a cellular telephone, and the like. These algorithmic descriptions and representations may be used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical, magnetic, or electromagnetic signals capable of being stored, transferred, combined, compared, and otherwise manipulated.

Principally for reasons of common usage, it has proven convenient at times to refer to these signals as bits, values, elements, symbols, characters, terms, numbers, or the like. However, the above and similar terms are to be associated with the appropriate physical quantities and are merely convenient labels applied to these quantities. Unless specifically stated otherwise, and as apparent from the following, it will be appreciated that throughout the present specification, discussions utilizing terms such as “executing”, “loading”, “sending”, “receiving”, “moving”, “storing” “waiting”, “reporting”, “creating” or the like, refer to the actions and processes of a computer system, or similar electronic device. The computer system, or similar electronic device, can manipulate and transform data represented as physical (electronic) quantities within the registers and memories of the computer system into other data similarly represented as physical quantities within the computer system memories, registers, or other information storage, transmission or display devices.

The present specification also discloses a system or an apparatus for performing the operations of these algorithms. Such a system may be specially constructed for the required purposes, or may comprise a general-purpose computer or other similar device selectively activated or reconfigured by a computer program stored. The algorithms presented herein are not inherently related to any particular computer or other apparatus. Various general-purpose machines may be used with programs in accordance with the teachings herein. Alternatively, the construction of more specialized apparatus to perform the required method steps may be appropriate.

In addition, embodiments of the present invention may be implemented as a computer program(s) or software. It would be apparent to a person skilled in the art that the individual steps of the methods described herein may be put into effect by computer code. The computer program is not intended to be limited to any particular programming language and implementation thereof. A variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention. Furthermore, one or more of the steps of the computer program may be performed in parallel rather than sequentially.

Such a computer program may be stored on any computer readable medium. The computer readable medium may comprise storage devices such as magnetic or optical disks, memory chips, or other storage devices suitable for interfacing with a general-purpose computer. The computer readable medium may also comprise a hard-wired medium such as the Internet system, or a wireless medium such as the GSM mobile telephone system. The computer program when loaded and executed on such a general-purpose computer effectively results in a system that implements one or more methods described herein.

Overview

The embodiments of the invention provide a data quality and integrity engine (DQIE) that is able to enforce business rules on data from a data source. The data source may comprise one or more databases, warehouses, and transaction systems. This is achieved by downloading data from the data source satisfying the business rules into a data repository that comprises a data structure that forms a model of the data. Preferably, the model is an enterprise model (EM). Errors are detected by the DQIE and automatically reported back to the Data Owner(s) of the data source, where the errors can be corrected at the source.

The DQIE can be used to integrate data into a single data set where the source data is derived from disparate Transaction Systems or databases. The DQIE enables business rules to be established, managed, and enforced. Preferably, the rules are enterprise level business rules. Further, data from disparate database systems can be delivered as an integrated data set. This reduces the costs of data management and business requirements.

By creating an enterprise model, enterprise-level business rules can be easily established and enforced on this enterprise model, rather than the source data.

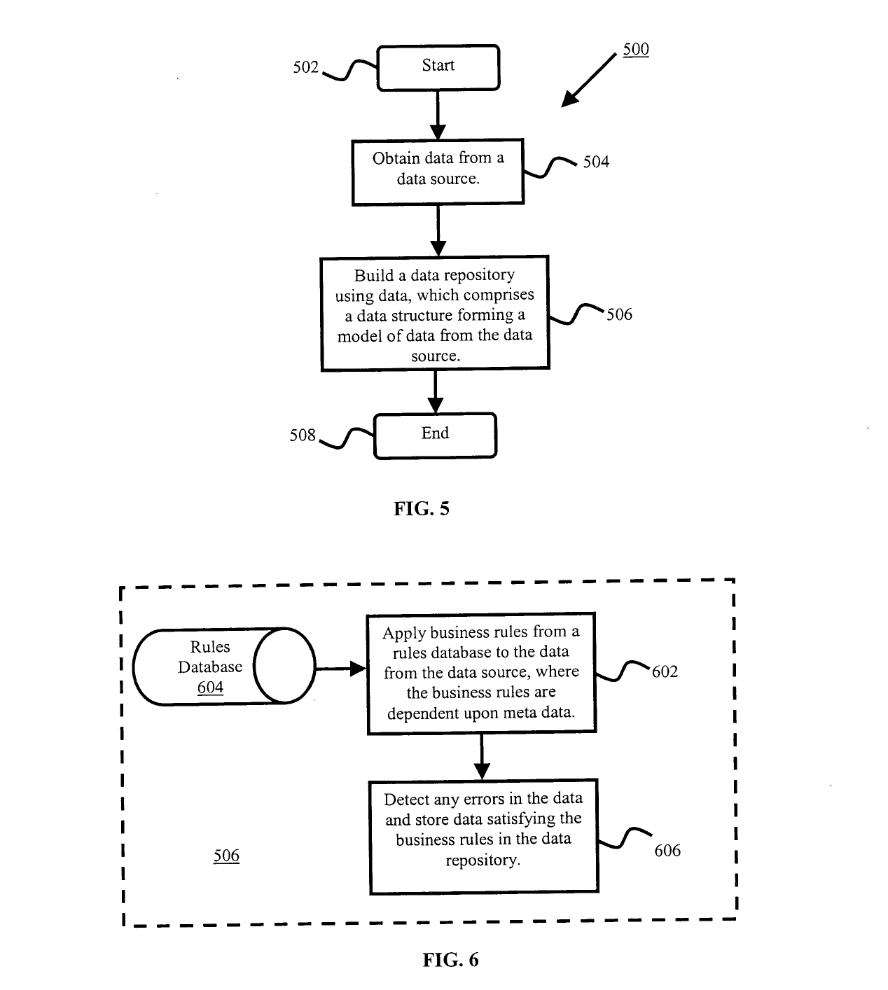

FIG. 5 is a high-level flow diagram illustrating a method 500 of ensuring data quality and integrity of a data set derived from the data source. Processing commences in step 502. In step 504, data is obtained from the data source. In step 506, the data repository is built using the data from the data source. The data repository comprises a data structure that forms the model of the data from the data source. Processing terminates in step 508. FIG. 6 is a detailed flowing diagram of the step 506 in FIG. 5. The building step 506 comprises steps 602 and 606. In step 602, the business rules from a rules database 604 are applied to the data from the data source. The business rules are dependent upon meta data. In step 604, any errors in the data are detected, and data satisfying the business rules are stored in the data repository. The details of FIGS. 5 and 6 are set forth in greater detail hereinafter.

System 200

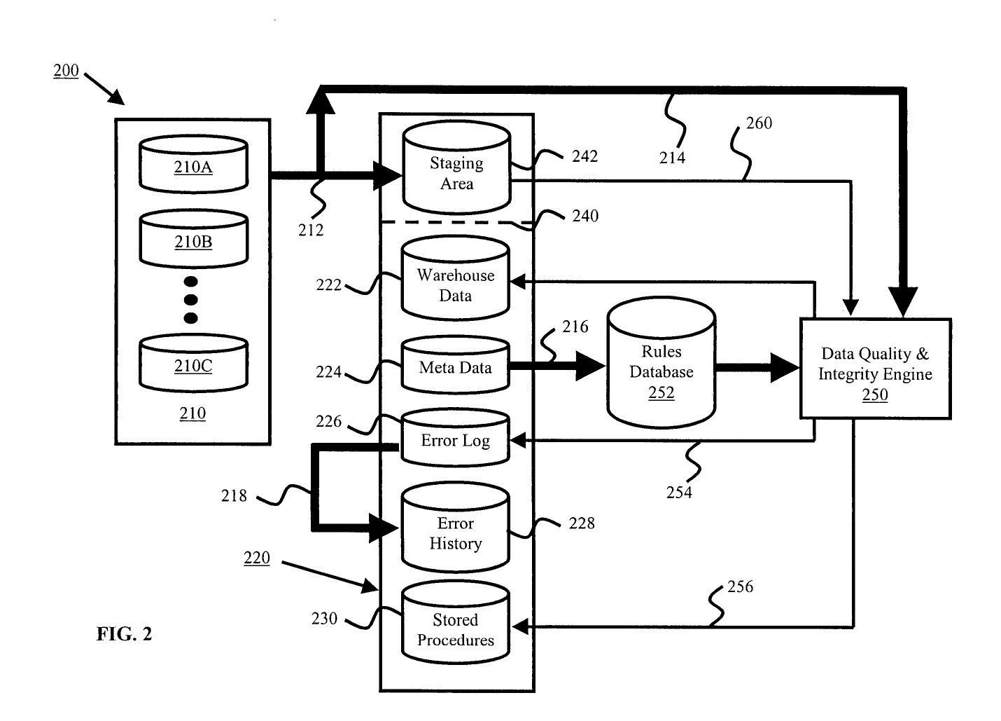

FIG. 2 is a block diagram illustrating an embodiment of the invention for ensuring data quality and integrity for data derived from a data source. Here the data source is preferably, but optionally, several different transaction systems. The system 200 of FIG. 2 comprises transaction systems 210, a data warehouse 220, and a data quality and integrity engine 250 and an associated rules database 252 that provide a virtual quality firewall 240 for the data warehouse.

The transaction systems 210 comprise a number of individual transaction systems 210A, 210B, . . . , 210C, which periodically load data 212 into the data warehouse 220. The individual transaction systems 210A, 210B, . . . , 210C may poorly interact with one or more of the other transaction systems, or not at all, making the enforcement of enterprise-level business rules across the transaction systems 210A, 210B, . . . , 210C, impossible or impracticable.

A staging area 242 receives the data 212 periodically loaded from the transaction systems 210. Rule by rule and row by row, data in the staging area 242 is accessed by the data quality and integrity engine (DQIE) 250. Individual data values are retrieved by the DQIE 250 from the staging areas 242 and checked for such things as range, format, uniqueness or relationship to other data values. The arrow 260 generally indicates that data is sampled by the DQIE 250 to check values and relationships. Little or no business rules are applied to the data 212 loaded into the staging area 242. The staging area 242 receives both good and bad data. Data transform rules are applied between the transaction systems 210A, . . . , 210C and the staging area 242, which may produce an intermediate file. Data may be brought into the staging area 242 in using variable character field text, for example. As is explained in greater detail hereinafter with regard to the DQIE 250, a virtual quality firewall 240 (indicated by a dashed line) is maintained between the staging area 242 and the data warehouse or repository 220. The DQIE 250 populates the warehouse data 222 with data from the staging area 242, and thus controls the flow of data from the staging area 242 into the warehouse data 222.

The data warehouse 220 comprises warehouse data 222, meta data 224, an error log 226, an error history 228, and stored procedures 230. The heart of the data warehouse is the relational store and this is where the Enterprise Model resides. Also business rules are checked and the data history is maintained. The meta data 224 stores information about the structure and relationships within the database 222. For example, there is preferably a table called “Table Joins”. This table contains table and Column IDs, together with the type of join and constraints, if any on the data range. By storing this information in a table, the DQIE 250 can automatically execute a single stored procedure 230 on a number of different tables. For example, a single rule can check for orphan rows in a parent/child relationship between many tables. Other meta data comprises Display Names to be used for Tables and Columns. Regarding the stored procedures 230, many modern database engines like Oracle and Microsoft SQL Server incorporate the ability to store executable procedures and triggers at the database level. Often stored procedures 230 are executed by triggers or other applications. The stored procedures 230 are the “teeth” of the DQIE 250 and are invoked by the DQIE 250. These procedures 230, together with parameter lists and SQL statements (both stored in the rules database 252) act together to check and enforce the business rules. All the procedural parts of the rules may be stored as SQL in the rules database 252, but are preferably and conveniently stored and run as the executable part of the rules as stored procedures 230.

The error log 226 provides input 218 to the error history 228. The data quality and integrity engine 250 is coupled to the rules database 252 that contains the enterprise business rules. The rules database 252 is separate from the data quality and integrity engine 250. The meta data 224 is coupled to the rules database 252. The DQIE 250 has access to the warehouse data 222. Further, the DQIE 250 provides error data 254 based on the warehouse data 222 to the error log 226 and can invoke 256 the stored procedures 230. Good data produced using the DQIE 250 can be exported as integrated data set for data delivery.

The periodic loading process of data 212 to the staging area 242 also triggers 214 the DQIE 250. Also, the DQIE 250 notifies the transaction systems 210 when errors are discovered in the source data, so that the source data may be corrected. These and other aspects of the system 200 are described in further detail hereinafter.

Rules Database 252

The rules database 252 comprises both data and meta-data that fully describe each Rule. The rule may be implemented using a SQL statement, for example. Importantly, the rules are not coded in the DQIE 250. That is, the rules are independent of the DQIE 250. This structure allows many of the rule attributes to be managed by system administrators, without the need for reprogramming. The data of this rules database 252 comprises the following attributes:
Rule type,
The rule name,
A plain English description of the rule,
Rule syntax,
At what point in the process the rule should be invoked,
Whether or not errant data should progress to the Enterprise Model 220,
The name of the Stored Procedure 230 that checks the rule,
The rule precedence,
The target Table ID,
The target Column Name,
Whether or not the rule is Active (On/Off),
Whether or not the rule is necessary for complete Data quality and integrity,
Error ID,
Whether or not the rule is Traceable back to the Source Data, and
A parameter list, if required by the Stored Procedure 230.
   Data History

As data is downloaded into the warehouse data 222, the data is compared with previous records, based on their Primary Key values. The result of this comparison allows each record to be marked as an Add, Modify, or Delete. This also allows a data history to be maintained by storing the changes in history tables. The DQIE 250 also uses this Data History feature to ensure that the “Current” view of the data only comprises “good” data. Preventing “bad” data from being included in the “current” view forms the virtual Quality Firewall 240.

Quality Firewall 240

Triggered by the data load and driven by the DQIE 250, data flows through various sets of tables in the data warehouse, from the staging area 242, through to the Enterprise Model (EM). Depending on the rule meta-data, failing to meet certain rules can prevent “bad” data from progressing through to the EM, thereby retaining past records as “current” data. The action of the DQIE 250 to prevent “bad” data from reaching the EM, forms a virtual “Quality Firewall” 240. The DQIE 250 may be implemented as software. The firewall 240 produced by the DQIE 250 can prevent bad data from moving out of the data warehouse 220.

Error Storage 226

Error data 254 detected by the DQIE 250 is stored in an error log 226, which comprises a series of error tables 226 that mimic the table names, in which the errors occurred. These tables store meta-data about each breach of every rule. These error tables comprise data such as the Primary Key value, the Rule ID, and in some instances the Column value, where the actual source value did not meet the column constraints.

Therefore, errors can be traced down to the column- and row-levels and displayed to the user, even if the errant source data fails to meet the column definitions in the enterprise-level model. Time stamping each row in the error tables, allows the error history 228 to be viewed either by table or by rule.

Error Reporting

Preferably, the DQIE 250 does not correct errors. Instead, errors are reported to the Data Owners of the source transaction systems 210. This reporting is may be done by e-mail, but other mechanisms may be practiced without departing from the scope and spirit of the invention. Data Owners may then view the errors using a User Interface (UI), but correct the errors in the source transaction systems 210.

Loading Process

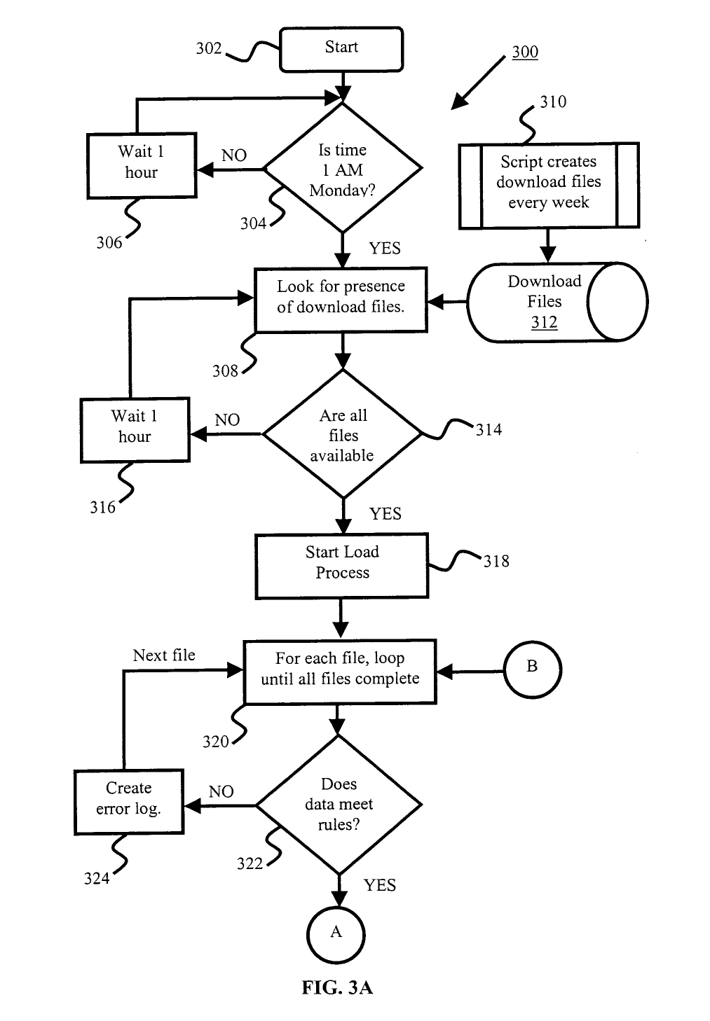

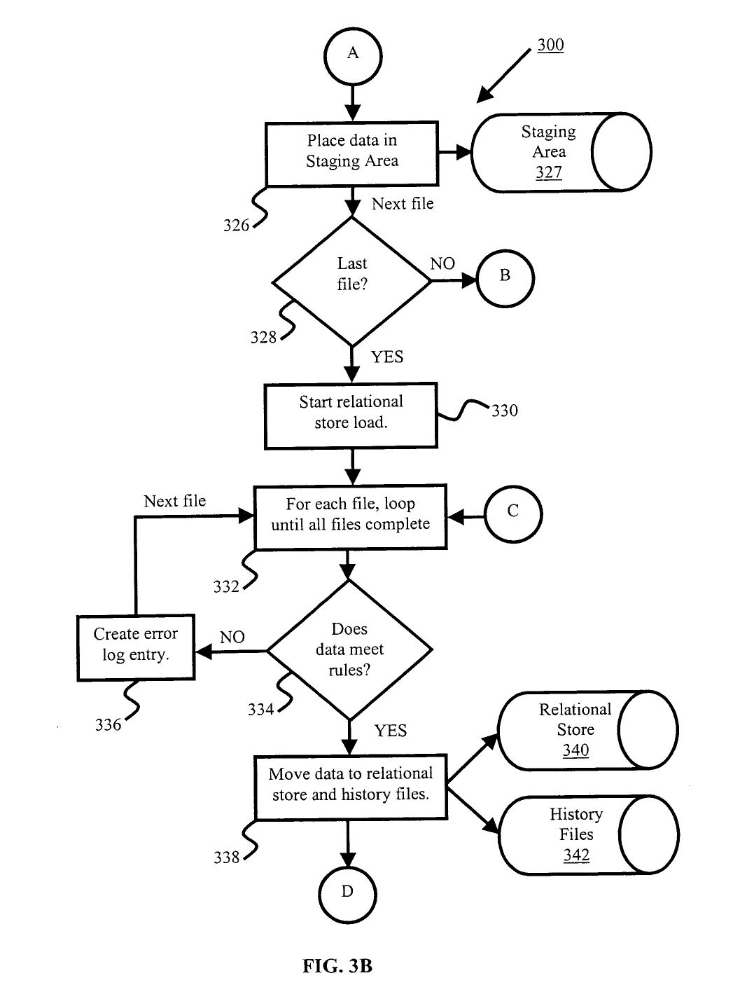

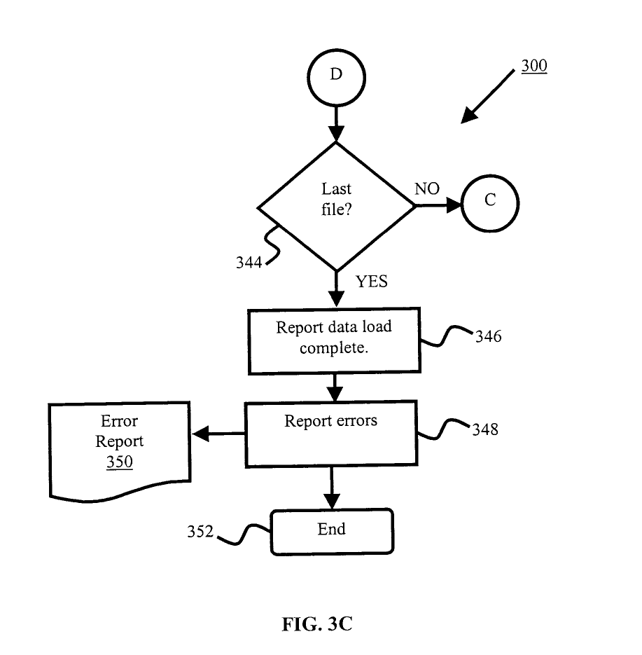

FIG. 3 (i.e., FIGS. 3A, 3B, and 3C) is a flow diagram illustrating the process 300 of loading data into the data warehouse 220 of FIG. 2. Processing commences in step 302. In decision step 304, a check is made to determine if a specified time and/or date has been reached (e.g., 1 AM on Monday). If step 304 returns false (NO), processing continues at step 306, in which a specified period of time (e.g. one hour) is allowed to elapse. Processing then continues at step 304. If step 304 returns true (YES), processing continues at step 308.

In step 308, a check is made looking for the presence of files to be downloaded from the transaction systems 210 of FIG. 2. Preferably, a script 310 creates the download files 312. This may done periodically (e.g. once a week), and the download files 312 produced are checked by step 308. In decision step 314, a check is made if all download files are available. If step 314 returns false (NO), a specified period of time (e.g., one hour) is allowed to elapse in step 316. From there, processing continues at step 308. If step 314 returns true (YES), processing continues at step 318. In step 318, the process of loading data commences. In step 320, a control loop is entered to process all files. Preferably, step 320 implements a for loop. Processing continues at decision step 322 for the current file.

In step 322, a check is made to determine if the data meet or satisfy at least a subset of the business rules 252. If step 322 returns false (NO), processing continues at step 324 and an error log is created. Processing then continues at step 320 for the next file. Otherwise, if step 322 returns true (YES), processing continues at step 326. In step 326, the date for the current file is placed into the staging area 327 (242 of FIG. 2). The next file is then checked at decision step 328, which checks to see if the next file is the last file to be processed in the for loop. If decision step 328 returns false (NO), processing continues at step 320. Otherwise, if step 328 returns true (YES), processing continues at step 330.

In step 330, loading into the relational store (222) commences. In step 332, a control loop is entered to process all files. Preferably, step 332 implements a for loop. Processing continues at decision step 334 for the current file. In step 334, a check is made to determine if the data of the current file satisfies all relevant business rules of the rules database 252. If step 334 returns false (NO), processing continues in step 336. In step 336, an entry in the error log 226 is created for this file. Processing of the next file continues at step 332. Otherwise if step 334 returns true (YES), processing continues at step 338. In step 338, the data is moved into the relational store 340 (222) and history files 342. Processing then continues with the next file at step 344.

In step 344, a check is made to determine if the last file has been reached. If step 344 returns false (NO), processing continues at step 332. Otherwise, if decision step 344 returns true (YES), processing continues at step 346. In step 346, completion of the data load is reported. The report may be sent via email to a system administrator. In step 348, errors are reported in an error report 350 to the transaction systems 210. In step 352, processing terminates.

Data Quality and Integrity Engine Process

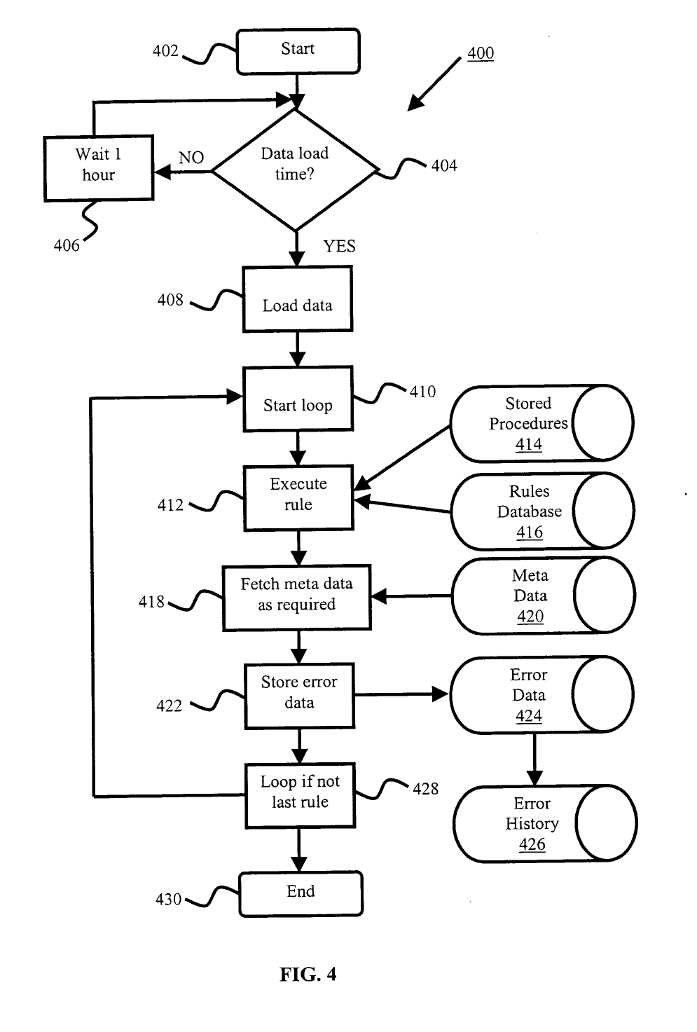

FIG. 4 is a flow diagram illustrating the processing 400 of the data quality and integrity engine 250 of FIG. 2. In step 402, processing commences. In step 404, a check is made to determine if the specified time for loading data has been reached. If step 404 returns false (NO), processing continues at step 406. In step 406, a specified or given period of time (e.g., one hour) is allowed to elapse. Processing then returns to step 404. If step 404 returns true (YES), processing continues at step 408. In step 408 data is loaded in the manner of FIG. 3. In step 410, a control loop (e.g. a do while or for loop) is started. In step 412, an enterprise-level business rule from the rules database 416 (252 in FIG. 2) is executed using the stored procedures 414 (230 in FIG. 2) on the data. In step 418, meta data is fetched 420 (224 in FIG. 2), as required. In step 422, any resulting error data 424 is stored in the error history 426 (228 in FIG. 2). In step 428, if the last rule has not been executed, processing continues at step 410. Otherwise processing terminates in step 430.

The data quality and integrity engine (DQIE) thereby advantageously establishes, manages, and enforces Enterprise-Level business rules across a number of disparate transaction systems. Further, the DQIE detects errors in the data and reports this back to the Data Owners, so that the errors can be corrected at the source. The DQIE integrates data into a single data set where the source data is derived from disparate transaction systems or databases. Further the separate rules database associated with the DQIE allows easy maintenance of the enterprise-level business rules.

The DQIE has the following advantages:
Because the rules are separate from the DQIE, the code within the DQIE can be “generic” and capable of executing any rule;
By editing the meta data via a suitable user interface, rules can be managed by a non-programmer;
Rules can be easily added, deleted, or edited; and
The rule meta data, including title and descriptive text, can be viewed by users. This allows users to relate particular breaches to the actual rule and to make comment where appropriate.
   Computer Implementation

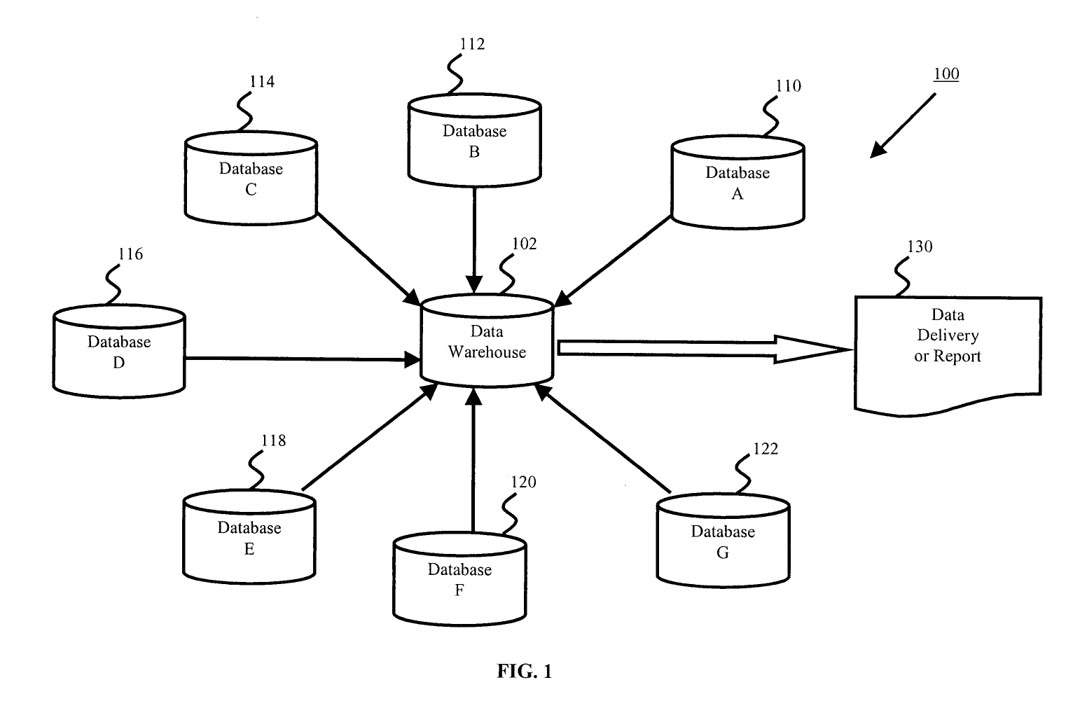

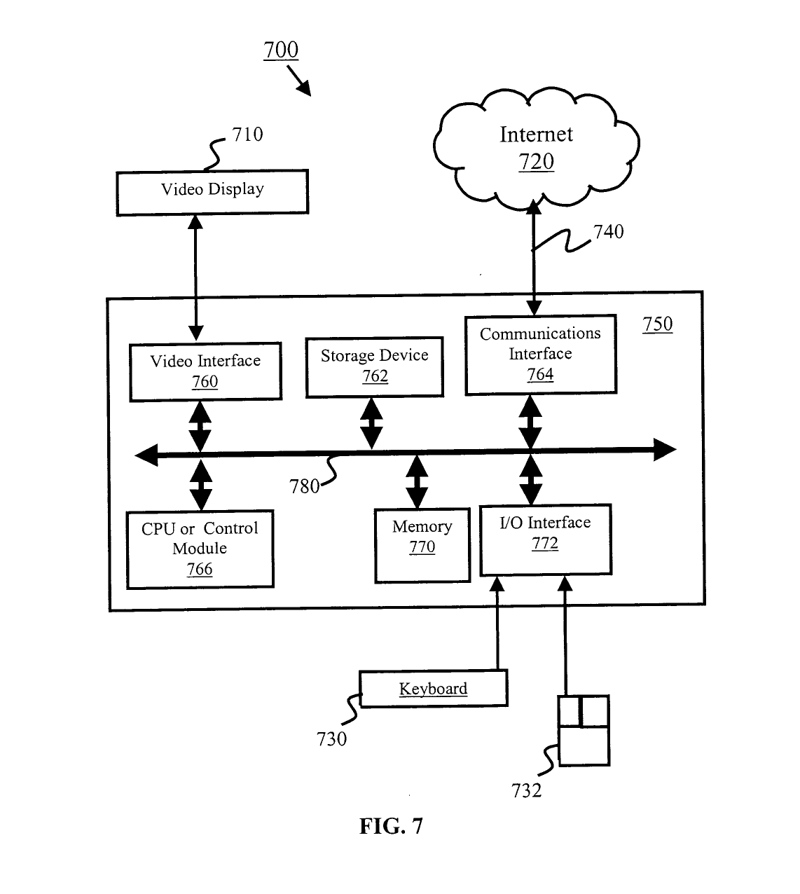

The methods of ensuring data quality and integrity of a data set derived from a data source may be practiced using one or more general-purpose computer systems and handheld devices, in which the processes of FIGS. 1 to 6 may be implemented as software, such as an application program executing within the computer system or handheld device. In particular, the steps of the method of ensuring data quality and integrity of a data set derived from a data source are effected, at least in part, by instructions in the software that are carried out by the computer. Software may include one or more computer programs, including application programs, an operating system, procedures and rules. The instructions may be formed as one or more code modules, each for performing one or more particular tasks. The software may be stored in a computer readable medium, comprising one or more of the storage devices described below, for example. The software is loaded into the computer from the computer readable medium and then executed by the computer. A computer readable medium having such software recorded on it is a computer program product. An example of a computer system 700 with which the embodiments of the invention may be practiced is depicted in FIG. 7.

In particular, the software may be stored in a computer readable medium, comprising one or more of the storage devices described hereinafter. The software is loaded into the computer from the computer readable medium and then carried out by the computer. A computer program product comprises a computer readable medium having such software or a computer program recorded on the medium that can be carried out by a computer. The use of the computer program product in the computer may effect an advantageous apparatus for ensuring data quality and integrity of a data set derived from a data source in accordance with the embodiments of the invention.

The computer system 700 may comprise a computer 750, a video display 710, and one or more input devices 730, 732. For example, an operator can use a keyboard 730 and/or a pointing device such as the mouse 732 (or touchpad, for example) to provide input to the computer. The computer system may have any of a number of other output devices comprising line printers, laser printers, plotters, and other reproduction devices connected to the computer. The computer system 700 can be connected to one or more other computers via a communication interface 764 using an appropriate communication channel 740 such as a modern communications path, a computer network, a wireless LAN, or the like. The computer network may comprise a local area network (LAN), a wide area network (WAN), an Intranet, and/or the Internet 720, for example.

The computer 750 may comprise one or more central processing unit(s) 766 (simply referred to as a processor hereinafter), memory 770 which may comprise random access memory (RAM) and read-only memory (ROM), input/output (10) interfaces 772, a video interface 760, and one or more storage devices 762. The storage device(s) 762 may comprise one or more of the following: a floppy disc, a hard disc drive, a magneto-optical disc drive, CD-ROM, DVD, a data card or memory stick, magnetic tape or any other of a number of non-volatile storage devices well known to those skilled in the art. For the purposes of this description, a storage unit may comprise one or more of the memory 770 and the storage devices 762.

Each of the components of the computer 750 is typically connected to one or more of the other devices via one or more buses 780, depicted generally in FIG. 7, that in turn comprise data, address, and control buses. While a single bus 780 is depicted in FIG. 7, it will be well understood by those skilled in the art that a computer or other electronic computing device such as a PDA or cellular phone may have several buses including one or more of a processor bus, a memory bus, a graphics card bus, and a peripheral bus. Suitable bridges may be utilised to interface communications between such buses. While a system using a processor has been described, it will be appreciated by those skilled in the art that other processing units capable of processing data and carrying out operations may be used instead without departing from the scope and spirit of the invention.

The computer system 700 is simply provided for illustrative purposes and other configurations can be employed without departing from the scope and spirit of the invention. Computers with which the embodiment can be practiced comprise IBM-PC/ATs or compatibles, one of the Macintosh™ family of PCs, Sun Sparcstation™, a workstation or the like. The foregoing are merely examples of the types of computers with which the embodiments of the invention may be practiced. Typically, the processes of the embodiments, described hereinafter, are resident as software or a program recorded on a hard disk drive as the computer readable medium, and read and controlled using the processor. Intermediate storage of the program and intermediate data and any data fetched from the network may be accomplished using the semiconductor memory.

In some instances, the program may be supplied encoded on a CD-ROM or a floppy disk, or alternatively could be read from a network via a modem device connected to the computer, for example. Still further, the software can also be loaded into the computer system from other computer readable medium comprising magnetic tape, a ROM or integrated circuit, a magneto-optical disk, a radio or infra-red transmission channel between the computer and another device, a computer readable card such as a PCMCIA card, and the Internet and Intranets comprising email transmissions and information recorded on websites and the like. The foregoing is merely an example of relevant computer readable mediums. Other computer readable mediums may be practiced without departing from the scope and spirit of the invention.

A small number of embodiments of the invention regarding methods, systems, and computer program products for ensuring data quality and integrity of a data set derived from a data source have been described. In the light of the foregoing, it will be apparent to those skilled in the art in the light of this disclosure that various modifications and/or substitutions may be made without departing from the scope and spirit of the invention.

1. A method of ensuring data quality and integrity of a data set derived from a data source, said method comprising the steps of:
obtaining data from said data source;
building a data repository using said data from said data source, said data repository comprising a data structure that forms a model of said data from said data source, said building step comprising the steps of:
applying business rules from a rules database to said data from said data source, said business rules dependent upon meta data; and
detecting any errors in said data and storing data satisfying said business rules in said data repository.

2. The method according to claim 1, further comprising the step of reporting said detected errors for correction of said errors in said data source.

3. The method according to claim 1, further comprising the step of providing an integrated data set for export from said data repository.

4. The method according to claim 1, wherein said data source comprises a plurality of transaction systems.

5. The method according to claim 4, further comprising the step of storing said data from said plurality of transaction systems in a staging area.

6. The method according to claim 1, wherein said model is an enterprise-level model and said business rules are enterprise level business rules.

7. The method according to claim 1, further comprising the step of feeding back said errors to said data source for correction.

8. The method according to claim 7, further comprising the step of correcting at least a portion of data of said data source dependent upon an error fed back to said data source.

9. The method according to claim 1, wherein said applying step comprises the step of invoking procedures stored in said data repository.

10. The method according to claim 1, wherein said meta data is stored in said data repository.

11. The method according to claim 1, comprising the step of loading said data from said data source into a staging area.

12. The method according to claim 11, further comprising the step of triggering said building step.

13. The method according to claim 1, wherein said rules database comprises one or more attributes for each rule selected from the group consisting of:
rule type,
rule name,
a text description of the rule,
rule syntax,
invocation of said rule,
reporting of erroneous data to said enterprise-level model,
name of a stored procedure for checking said rule,
rule precedence,
a target table identifier,
a target column name,
activation status of said rule,
status information of whether or not said rule is required for complete data quality and integrity,
an error identifier,
status information of whether or not said rule is traceable back to said data from said transaction systems, and
a parameter list, if required by said stored procedure.

14. The method according to claim 1, wherein each rule of said rules database comprises a SQL statement.

15. A system for ensuring data quality and integrity of a data set derived from a data source, said system comprising the steps of:
means for obtaining data from said data source;
means for building a data repository using said data from said data source, said data repository comprising a data structure that forms a model of said data from said data source, said building means comprising:
means for applying business rules from a rules database to said data from said data source, said business rules dependent upon meta data; and
means for detecting any errors in said data and storing data satisfying said business rules in said data repository.

16. The system according to claim 15, further comprising means for reporting said detected errors for correction of said errors in said data source.

17. The system according to claim 15, further comprising means for providing an integrated data set for export from said data repository.

18. The system according to claim 15, wherein said data source comprises a plurality of transaction systems.

19. The system according to claim 18, further comprising means for storing said data from said plurality of transaction systems in a staging area.

20. The system according to claim 15, wherein said model is an enterprise-level model and said business rules are enterprise level business rules.

21. The system according to claim 15, further comprising means for feeding back said errors to said data source for correction.

22. The system according to claim 21, further comprising means for correcting at least a portion of data of said data source dependent upon an error fed back to said data source.

23. The system according to claim 15, wherein said applying means comprises means for invoking procedures stored in said data repository.

24. The system according to claim 15, wherein said meta data is stored in said data repository.

25. The system according to claim 15, comprising means for loading said data from said data source into a staging area.

26. The system according to claim 25, further comprising means for triggering said building means.

27. The system according to claim 15, wherein said rules database comprises one or more attributes for each rule selected from the group consisting of:
rule type,
rule name,
a text description of the rule,
rule syntax,
invocation of said rule,
reporting of erroneous data to said enterprise-level model,
name of a stored procedure for checking said rule,
rule precedence,
a target table identifier,
a target column name,
activation status of said rule,
status information of whether or not said rule is required for complete data quality and integrity,
an error identifier,
status information of whether or not said rule is traceable back to said data from said transaction systems, and
a parameter list, if required by said stored procedure.

28. The system according to claim 15, wherein each rule of said rules database comprises a SQL statement.

29. A computer program product having a computer readable medium with a computer program recorded therein for ensuring data quality and integrity of a data set derived from a data source, said computer program product comprising:
computer program code means for obtaining data from said data source;
computer program code means for building a data repository using said data from said data source, said data repository comprising a data structure that forms a model of said data from said data source, said computer program code means for building comprising:
computer program code means for applying business rules from a rules database to said data from said data source, said business rules dependent upon meta data; and
computer program code means for detecting any errors in said data and storing data satisfying said business rules in said data repository.

30. The computer program product according to claim 29, further comprising computer program code means for reporting said detected errors for correction of said errors in said data source.

31. The computer program product according to claim 29, further comprising computer program code means for providing an integrated data set for export from said data repository.

32. The computer program product according to claim 29, wherein said data source comprises a plurality of transaction systems.

33. The computer program product according to claim 32, further comprising computer program code means for storing said data from said plurality of transaction systems in a staging area.

34. The computer program product according to claim 29, wherein said model is an enterprise-level model and said business rules are enterprise level business rules.

35. The computer program product according to claim 29, further comprising computer program code means for feeding back said errors to said data source for correction.

36. The computer program product according to claim 35, further comprising computer program code means for correcting at least a portion of data of said data source dependent upon an error fed back to said data source.

37. The computer program product according to claim 29, wherein said computer program code means for applying comprises computer program code means for invoking procedures stored in said data repository.

38. The computer program product according to claim 29, wherein said meta data is stored in said data repository.

39. The computer program product according to claim 29, comprising computer program code means for loading said data from said data source into a staging area.

40. The computer program product according to claim 39, further comprising computer program code means for triggering said computer program code means for building.

41. The computer program product according to claim 29, wherein said rules database comprises one or more attributes for each rule selected from the group consisting of:
rule type,
rule name,
a text description of the rule,
rule syntax,
invocation of said rule,
reporting of erroneous data to said enterprise-level model,
name of a stored procedure for checking said rule,
rule precedence,
a target table identifier,
a target column name,
activation status of said rule,
status information of whether or not said rule is required for complete data quality and integrity,
an error identifier,
status information of whether or not said rule is traceable back to said data from said transaction systems, and
a parameter list, if required by said stored procedure.

42. The computer program product according to claim 29, wherein each rule of said rules database comprises a SQL statement.

43. A system for ensuring data quality and integrity of a data set derived from a data source, said system comprising:
a data repository comprising a relational store and stored procedures;
a rules database comprising enterprise business rules affecting the transfer of data from said data source to said data repository;
a data quality and integrity engine coupled to said rules database for invoking said stored procedures of said data repository on said data, said data quality and integrity engine for detecting errors in said data and for controlling transfer of said data into said data repository dependent upon said rules database.

44. The system according to claim 43, wherein said data repository further comprises an error log, said error log comprising data about one or more errors detected by said data quality and integrity engine.

45. The system according to claim 44, wherein said data repository further comprises an error history coupled to said error log.

46. The system according to claim 43, wherein said data source comprises a plurality of transaction systems.

47. The system according to claim 43, further comprising a staging area for storing at least a portion of said data from said data source, said staging area being coupled to said data quality and integrity engine.

48. The system according to claim 47, further comprising a virtual quality firewall separating said staging area and said data repository.

49. The system according to claim 47, wherein said data quality and integrity engine controls transfer of data from said data set from said staging area into said relational store dependent upon said rules database.

50. The system according to claim 43, wherein said data repository further comprises meta data, said rules database being dependent upon said meta data.

51. A system for ensuring data quality and integrity of a data set derived from a data source, said system comprising:
a storage unit for storing data and computer program code to be carried out by a processing unit, said storage unit implementing at least a portion of a data repository, said data repository comprising a data structure that forms a model of data from said data source;
a processing unit coupled to said at least said storage unit, said processing unit being programmed with said computer program code to:
obtain said data from said data source;
populating said data repository using said data from said data source, said populating step comprising:
applying business rules from a rules database to said data from said data source, said business rules dependent upon meta data; and
detecting any errors in said data and storing data satisfying said business rules in said data repository.

52. The system according to claim 51, wherein said processing unit is programmed with computer program code to report said detected errors for correction of said errors in said data source.

53. The system according to claim 51, wherein said processing unit is programmed with computer program code to provide an integrated data set for export from said data repository.

54. The system according to claim 51, wherein said data source comprises a plurality of transaction systems.

55. The system according to claim 54, wherein said processing unit is programmed with computer program code to store said data from said plurality of transaction systems in a staging area.

56. The system according to claim 51, wherein said model is an enterprise-level model and said business rules are enterprise level business rules.

57. The system according to claim 51, wherein said applying comprises invoking procedures stored in said data repository.

58. The system according to claim 51, wherein said meta data is stored in said data repository.

59. The system according to claim 51, wherein said processing unit is programmed with computer program code to load said data from said data source into a staging area.

60. The system according to claim 51, wherein said rules database comprises one or more attributes for each rule selected from the group consisting of:
rule type,
rule name,
a text description of the rule,
rule syntax,
invocation of said rule,
reporting of erroneous data to said enterprise-level model,
name of a stored procedure for checking said rule,
rule precedence,
a target table identifier,
a target column name,
activation status of said rule,
status information of whether or not said rule is required for complete data quality and integrity,
an error identifier,
status information of whether or not said rule is traceable back to said data from said transaction systems, and
a parameter list, if required by said stored procedure.
